(19) United States
(12) Patent Application Publication
(10) Pub. No.: US 2024/0429565 A1
(43) Pub. Date: Dec. 26, 2024

(54) BATTERY PACK

(71) Applicant: MURATA MANUFACTURING CO., LTD., Kyoto (JP)

(72) Inventor: Yoshiyuki BANNAI, Kyoto (JP)

(21) Appl. No.: 18/824,410

(22) Filed: Sep. 4, 2024

Related U.S. Application Data
(63) Continuation of application No. PCT/JP2023/002538, filed on Jan. 26, 2023.

(30) Foreign Application Priority Data
Mar. 28, 2022 (JP) 2022-051514

(51) Int. Cl. H01M 50/505; H01M 50/213; H01M 50/227; H01M 50/233; H01M 50/271; H01M 50/298; H01M 50/516

(52) U.S. Cl. CPC H01M 50/505; H01M 50/213; H01M 50/227; H01M 50/233; H01M 50/271; H01M 50/298; H01M 50/516

(57) ABSTRACT

A battery pack is provided and includes a plurality of cylindrical cells arranged in a manner that a plurality of electrode terminals face a same direction, a cell holder made from resin that holds arrangement of a plurality of the cylindrical cells, a tab extending in a planar direction parallel to a direction orthogonal to a longitudinal direction of the cylindrical cell, and a case. The cell holder includes a holder main body in which a plurality of cell accommodation portions are provided in the planar direction and a bottom wall extending in the planar direction, and a through hole penetrating the bottom wall, the bottom wall includes a plurality of lid walls covering the cell accommodation portion, and a plurality of annular walls, the tab includes a plurality of welded portions which are welded to the electrode terminal through the through hole, a wiring portion that extends in the planar direction from the welded portion and connects the welded portions to each other, at least one of the lid wall and the wiring portion is provided with a thin portion having small thickness in the longitudinal direction, and the thin portion is arranged on an inner side of the annular wall as viewed from the longitudinal direction.

### CROSS REFERENCE TO RELATED APPLICATIONS

The present application is a continuation of PCT patent application no. PCT/JP2023/002538, filed on Jan. 26, 2023, which claims priority to Japanese patent application no. 2022-051514, filed on Mar. 28, 2022, the entire contents of which are incorporated herein by reference.

### BACKGROUND

The present disclosure relates to a battery pack.

A battery unit provided in a battery pack has a plurality of cells. In a case where the cell is a cylindrical cell, the cylindrical cells are arranged in a direction orthogonal to a longitudinal direction of the cylindrical cell, and an electrode terminal is arranged on the same plane. In order to hold such arrangement of a plurality of the cylindrical cells, the battery unit has a cell holder.

The cell holder of a patent document below is provided with a plurality of cell accommodation portions in which a cylindrical cell is accommodated. Note that the cell accommodation portion is a cylindrical hole. Further, an end portion of the cell accommodation portion is opened. Then, a tab is arranged in an opening direction, and the tab and an electrode terminal of the cylindrical cell are welded. The tab extends across adjacent cell accommodation portions and connects electrode terminals of the adjacent cylindrical cells. Furthermore, a closing wall is provided between an end portion of the cell holder and the tab so that adjacent cell accommodation portions do not communicate with each other. Therefore, if the cylindrical cell generates heat and a high-temperature and high-pressure gas is ejected from an end portion of the cylindrical cell, the gas does not enter an adjacent cell accommodation portion.

### SUMMARY

The present disclosure relates to a battery pack.

However, when processing accuracy of the tab and the closing wall is low, a gap is generated between the closing wall and the tab or between a gap closing wall and the cell accommodation portion. Therefore, development of a battery pack capable of preventing entry of high-temperature and high-pressure gas into an adjacent cell accommodation portion regardless of processing accuracy of the tab has been desired.

In view of the above problem, for example, the present disclosure, in an embodiment, relates to providing a battery pack that prevents gas from entering an adjacent cell accommodating space.

A battery pack according to an embodiment of the present disclosure includes a plurality of cylindrical cells arranged in a manner that a plurality of electrode terminals face the same direction, a cell holder made from resin that holds arrangement of a plurality of the cylindrical cells, a tab made from metal extending in a planar direction parallel to a direction orthogonal to a longitudinal direction of the cylindrical cell, and a case that accommodates a plurality of the cylindrical cells, the cell holder, and the tab. The cell holder includes a holder main body on which a plurality of cell accommodation portions extending in the longitudinal direction are provided in the planar direction, a bottom wall extending in the planar direction and connected to an end portion of the holder main body, and a through hole penetrating the bottom wall. The bottom wall includes a plurality of lid walls covering the cell accommodation portion, and a plurality of annular walls extending from the lid wall toward an inner surface of the case. The tab includes a plurality of welded portions which are arranged on each of a plurality of the lid walls and are welded to the electrode terminal through the through hole, and a wiring portion which extends in the planar direction from the welded portion and connects the welded portions. At least one of the lid wall and the wiring portion is provided with a thin portion having small thickness in the longitudinal direction. The thin portion is arranged on the inner side of the annular wall as viewed from the longitudinal direction.

According to the battery pack of the present disclosure, in an embodiment, gas ejected from the cylindrical cell cleaves the thin portion and moves into the annular wall. Therefore, the gas does not move to the adjacent cell accommodation portion. Further, this effect does not depend on processing accuracy of the tab.

### BRIEF DESCRIPTION OF THE FIGURES

FIG. 1 is an exploded perspective view of a battery pack according to an embodiment.

FIG. 2 is an exploded perspective view of a battery unit.

FIG. 3 is a diagram illustrating a state in which a tab is taken out from a bottom wall of a first cell holder.

FIG. 4 is a diagram illustrating a state in which the tab is taken out from a bottom wall of a second cell holder.

FIG. 5 is a diagram of the first cell holder as viewed from a first longitudinal direction.

FIG. 6 is a sectional view taken along line VI-VI in FIG. 5.

FIG. 7 is a perspective view of an end portion on a positive electrode side of a cylindrical cell.

FIG. 8 is a sectional view illustrating a state in which the cylindrical cell is accommodated in a cell accommodation portion.

FIG. 9 is a sectional view illustrating a gas path in the cylindrical cell.

FIG. 10 is a sectional view illustrating a gas path in the cell holder.

FIG. 11 is a diagram illustrating a first tab of an embodiment.

FIG. 12 is a sectional view taken along line XI-XI in

FIG. 11.

FIG. 13 is an enlarged diagram enlarging the first cell holder according to an embodiment.

FIG. 14 is a diagram illustrating a second tab of an embodiment.

FIG. 15 is an enlarged diagram enlarging the first cell holder according to an embodiment.

FIG. 16 is a perspective view of a bottom wall side of the cell holder of an embodiment.

FIG. 17 is a perspective view of the bottom wall side of the cell holder of an embodiment.

FIG. 18 is an exploded perspective view of the battery pack of an embodiment.

FIG. 19 is a sectional view of an embodiment.

FIG. 20 is a perspective view illustrating a second case of an embodiment.

### DETAILED DESCRIPTION

Hereinafter, the present disclosure will be described in further detail including with reference to the drawings according to an embodiment. The present disclosure is not limited thereto. Further, constituent elements disclosed in an embodiment below can be suitably combined with each other.

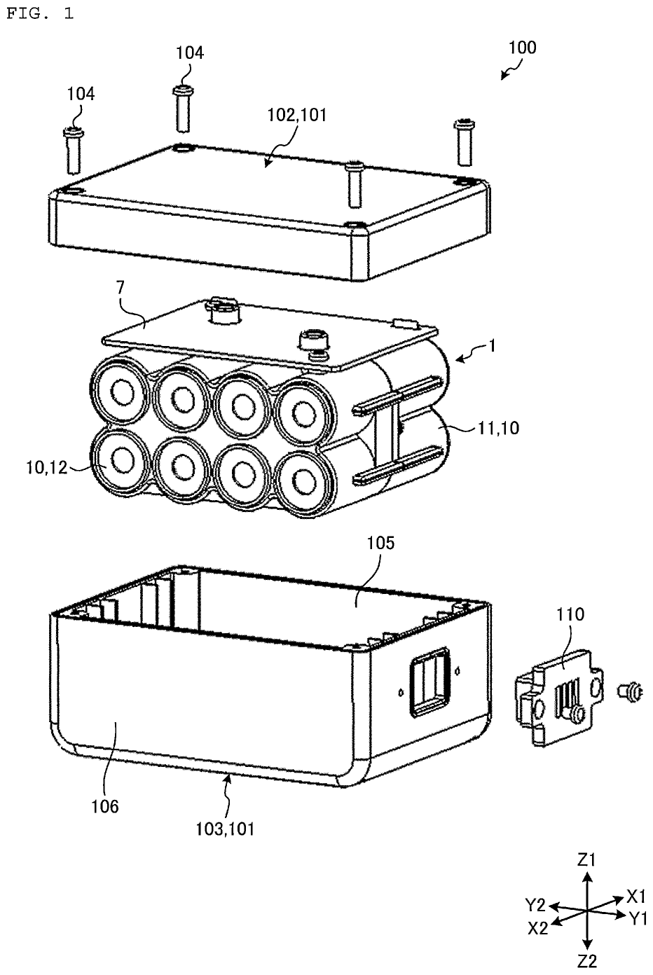

FIG. 1 is an exploded perspective view of a battery pack according to a first embodiment. As illustrated in FIG. 1, a battery pack 100 includes a battery unit 1 and a case 101 in which the battery unit 1 is accommodated.

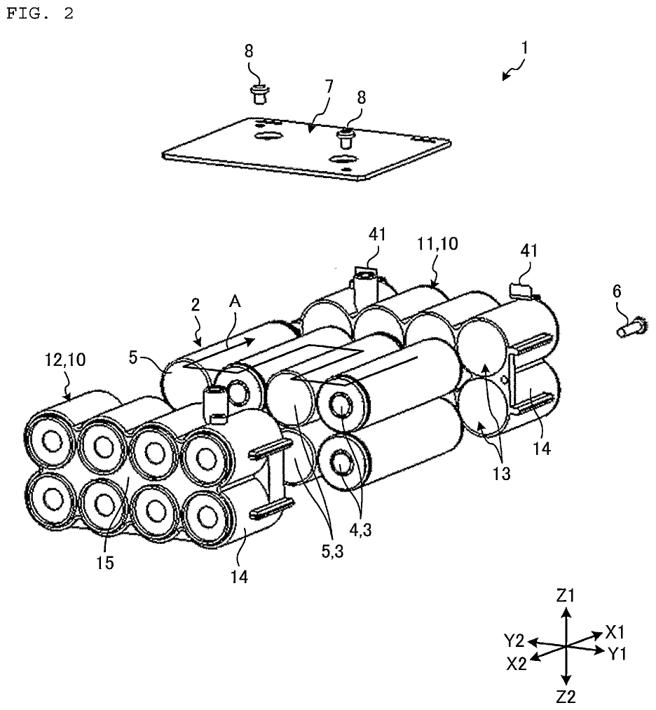

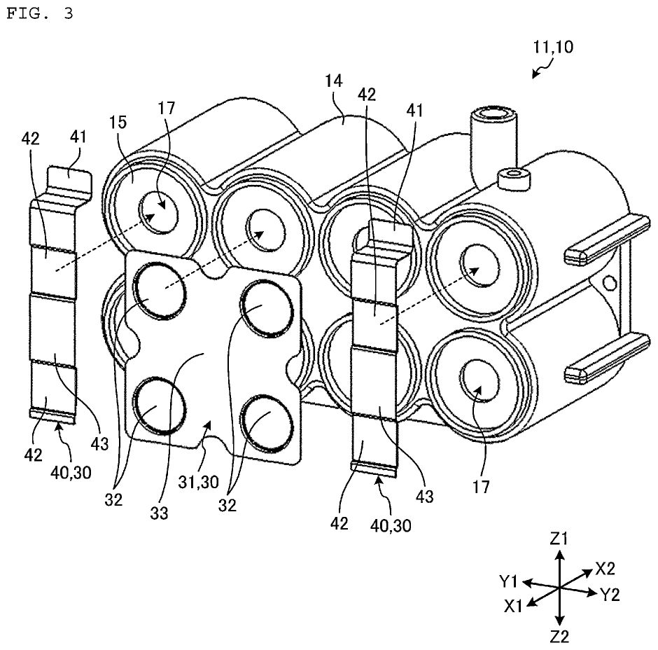

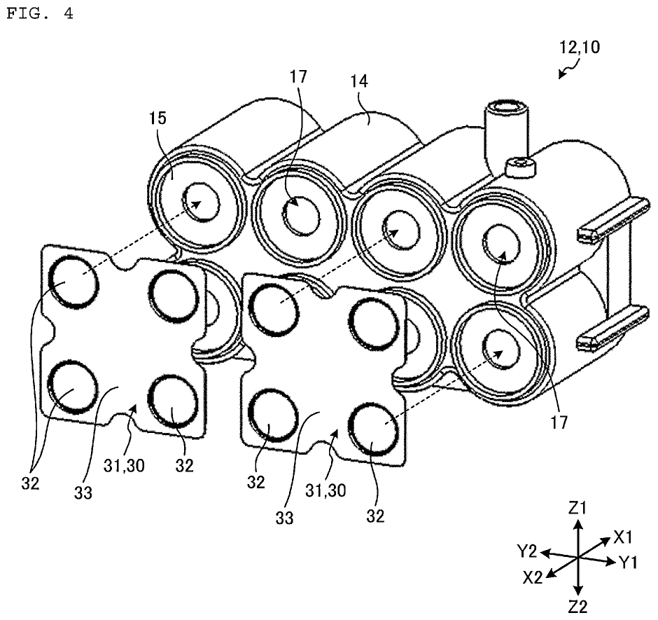

FIG. 2 is an exploded perspective view of the battery unit. As illustrated in FIG. 2, the battery unit 1 includes a plurality of cylindrical cells 2, a cell holder 10, a tab 30 (see FIGS. 3 and 4), and a control board 7. Hereinafter, a direction in which the cylindrical cell 2 extends is referred to as a longitudinal direction. An electrode terminal 3 is provided at an end portion in the longitudinal direction of the cylindrical cell 2. More specifically, a positive electrode terminal 4 is provided at one end in the longitudinal direction of the cylindrical cell 2, and a negative electrode terminal 5 is provided at another end in the longitudinal direction.

In the present embodiment, eight of the cylindrical cells 2 are provided. Note that, in the present disclosure, the number of the cylindrical cells 2 is not particularly limited. Eight of the cylindrical cells 2 are arranged such that a plurality of the electrode terminals 3 face the same direction. Further, eight of the cylindrical cells 2 are arranged in a manner that four are arranged in a direction (hereinafter, referred to as a width direction) intersecting the longitudinal direction and two are arranged in a direction (hereinafter, referred to as a stacking direction) intersecting both the longitudinal direction and the width direction. Furthermore, eight of the cylindrical cells 2 are arranged such that the electrode terminals 3 of the cylindrical cells 2 are located on the same plane. Note that the same plane is a plane extending in the width direction and the stacking direction. Hereinafter, a direction parallel to the same plane is referred to as a planar direction. Other than the above, in the battery pack of the present disclosure, a plurality of the electrode terminals 3 do not need to be arranged on the same plane. That is, a plurality of the electrode terminals 3 may be arranged so as to be shifted in the longitudinal direction.

With respect to a direction of the electrode terminal 3 of the cylindrical cell 2, two of the cylindrical cells 2 arranged in the stacking direction are arranged such that the same electrode terminals 3 face one side in the longitudinal direction. Then, two of the cylindrical cells 2 arranged in the stacking direction are connected in parallel by the tab 30 (see FIGS. 3 and 4). Further, four pairs of the cylindrical cells 2 arranged in the width direction (two of the cylindrical cells 2 arranged in the stacking direction) are arranged such that the positive electrode terminal 4 and the negative electrode terminal 5 face alternately with respect to one side in the longitudinal direction. Then, four pairs of the cylindrical cells 2 arranged in the width direction are directly connected by the tab 30 such that current as indicated by an arrow A in FIG. 2 flows. From the above, in eight cylindrical cells, four of two of the cylindrical cells 2 connected in parallel are connected in series.

The cell holder 10 includes a first cell holder 11 and a second cell holder 12. The first cell holder 11 is a resin product arranged on one side in the longitudinal direction with respect to eight of the cylindrical cells 2. The second cell holder 12 is a resin product arranged on another side in the longitudinal direction with respect to eight of the cylindrical cells 2. Hereinafter, a direction in which the first cell holder 11 is arranged as viewed from eight cylindrical cells is referred to as a first longitudinal direction X1, and the opposite direction is referred to as a second longitudinal direction X2.

Each of the first cell holder 11 and the second cell holder 12 includes a holder main body 14 provided with eight cell accommodation portions 13, and a bottom wall 15 covering an end portion of the cell accommodation portion 13. The cell accommodation portion 13 is a hole extending in the longitudinal direction, and has a circular sectional shape. An end portion in the first longitudinal direction X1 of the cylindrical cell 2 is inserted into the cell accommodation portion 13 of the first cell holder 11. An end portion in the second longitudinal direction X2 of the cylindrical cell 2 is inserted into the cell accommodation portion 13 of the second cell holder 12. That is, eight of the cylindrical cells 2 are sandwiched between the first cell holder 11 and the second cell holder 12 in the longitudinal direction. Then, the first cell holder 11 and the second cell holder 12 are fastened in the longitudinal direction by a screw 6. By the above, arrangement of eight of the cylindrical cells 2 is maintained.

The control board 7 is mounted on the cell holder 10 and fixed to the cell holder 10 by a screw 8. The control board 7 suppresses overdischarge and overcharge of the cylindrical cell 2. Hereinafter, a direction in which the control board 7 is arranged as viewed from eight of the cylindrical cells 2 in the stacking direction is referred to as a first stacking direction Z1, and the opposite direction is referred to as a second stacking direction Z2.

FIG. 3 is a diagram illustrating a state in which the tab is taken out from the bottom wall of the first cell holder. FIG. 4 is a diagram illustrating a state in which the tab is taken out from the bottom wall of the second cell holder. As illustrated in FIGS. 3 and 4, the bottom wall 15 of the first cell holder 11 and the second cell holder 12 extends in a planar direction. Further, a plurality of the tabs 30 are embedded in the bottom wall 15 of the first cell holder 11 and the second cell holder 12 (see an arrow in FIGS. 3 and 4).

The tab 30 is a metal plate extending in the planar direction. A plurality of the tabs 30 include a first tab 31 that connects the electrode terminals 3 of four of the cylindrical cells 2 adjacent to each other in the stacking direction and the width direction, and a second tab 40 that connects electrodes of two cells adjacent to each other in the stacking direction. As illustrated in FIG. 3, in the first cell holder 11, the first tab 31 is embedded in a central portion, and the second tabs 40 are embedded one by one on both sides in the width direction. As illustrated in FIG. 4, in the second cell holder 12, two of the first tabs 31 are embedded side by side in the width direction.

The first tab 31 has a quadrangular shape as viewed in the longitudinal direction. The first tab 31 is provided with a welded portion 32 projecting inward in the longitudinal direction. The welded portion 32 is a portion welded to the electrode terminal 3 of the cylindrical cell 2. The welded portion 32 is embedded so as to overlap a through hole 17 of the bottom wall 15 (see an arrow in FIGS. 3 and 4). Two of the welded portions 32 are provided in each of the stacking direction and the width direction. A plate-like portion other than the welded portion 32 of the first tab 31 is a wiring portion 33 through which current flows.

The second tab 40 is longer in the stacking direction than in the width direction. An electrode tab 41 is provided at an end portion in the first stacking direction Z1 of the second tab 40. The electrode tab 41 is not embedded in the bottom wall 15 and is in a state of projecting in the stacking direction from the cell holder 10 (see FIG. 2). In the second tab 40, two welded portions 42 projecting inward in the longitudinal direction are provided apart from each other in the stacking direction. The welded portion 42 is embedded so as to overlap the through hole 17 of the bottom wall 15 (see an arrow in FIGS. 3 and 4). Further, a portion other than the welded portion 42 and the electrode tab 41 of the second tab 40 is formed as a wiring portion 43. Note that details of the bottom wall 15 and the tab 30 will be described later.

As illustrated in FIG. 1, the case 101 is a housing made from resin. The case 101 includes a first case 102 arranged in the first stacking direction Z1 and a second case 103 arranged in the second stacking direction Z2. The second case 103 is a bottomed cylindrical container that opens in the first stacking direction Z1. The first case 102 is a bottomed cylindrical container that opens in the second stacking direction Z2. The first case 102 and the second case 103 are fastened by a bolt 104.

The second case 103 has a pair of facing walls 105 and 106 facing each other in the longitudinal direction. The second case 103 is longer in the stacking direction than the first case 102 and has a larger internal capacity. Therefore, a pair of the facing walls 105 and 106 face the bottom wall 15 of the cell holder 10.

An external terminal 110 is provided on a wall portion of the second case 103. The external terminal 110 is connected to two of the electrode tabs 41 (see FIG. 2) of a battery unit. Further, the external terminal 110 is arranged in the width direction with respect to the cylindrical cell 2. Hereinafter, in the width direction, a direction in which the external terminal 110 is arranged as viewed from the cylindrical cell 2 is referred to as a first width direction Y1, and the opposite direction is referred to as a second width direction Y2.

Next, details of the bottom wall 15 and the tab 30 of the cell holder 10 will be described. Note that a shape of the bottom wall 15 of the first cell holder 11 and a shape of the bottom wall 15 of the second cell holder 12 are the same. Therefore, the first cell holder 11 will be described below, and description of the second cell holder 12 will be omitted.

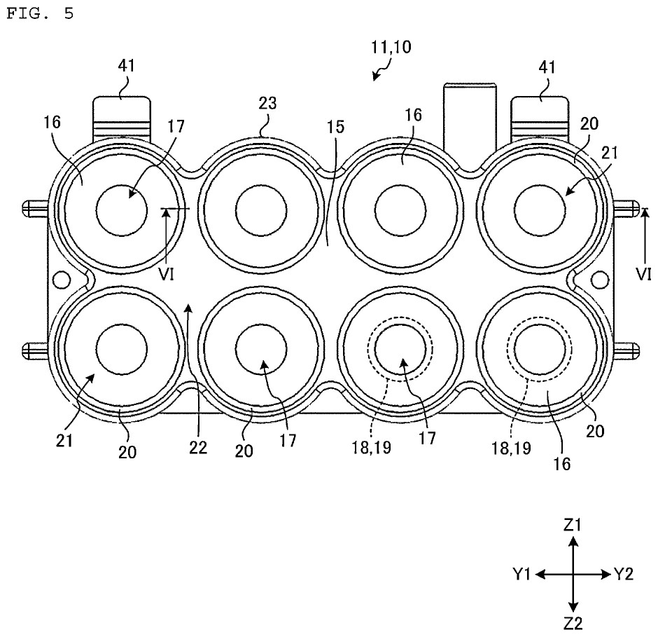

FIG. 5 is a diagram of the first cell holder as viewed from the first longitudinal direction. As illustrated in FIG. 5, the bottom wall 15 of the first cell holder 11 extends in the planar direction. A part of the bottom wall 15 forms a circular lid wall 16 covering the first longitudinal direction X1 of the cell accommodation portion 13. Therefore, the bottom wall 15 has eight of the lid walls 16. The circular through hole 17 is provided in a central portion of the lid wall 16.

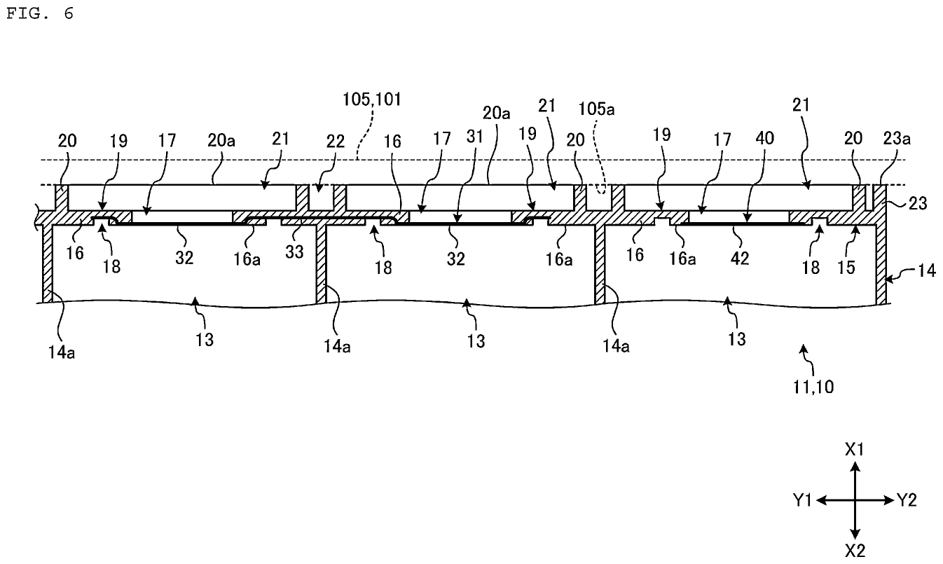

FIG. 6 is a sectional view taken along line VI-VI in FIG. 5. As illustrated in FIG. 6, the holder main body 14 has a plurality of partition walls 14a that partition the cell accommodation portion 13. The lid wall 16 is connected to the partition wall 14a. That is, adjacent ones of the cell accommodation portions 13 do not communicate with each other unless the partition wall 14a is cleaved by gas. From the above, the cell accommodation portions 13 do not communicate with each other regardless of processing accuracy of the tab 30.

The lid wall 16 is provided with an annular wall 20 projecting in the first longitudinal direction X1. Hereinafter, a space inside the annular wall 20 is referred to as an annular space 21. As illustrated in FIG. 5, the annular wall 20 has a cylindrical shape when viewed from the longitudinal direction. The annular wall 20 is provided on each of the lid walls 16, and eight of the annular walls 20 in total are provided. Each of the annular walls 20 is spaced apart from the annular wall 20 adjacent in the width direction and the stacking direction. Therefore, a separation space 22 that separates the annular walls 20 from each other is provided between the annular walls 20.

The bottom wall 15 is provided with an outer peripheral wall 23 projecting in the first longitudinal direction X1. The outer peripheral wall 23 is an annular wall surrounding an outer peripheral side of eight of the annular walls 20 and the separation space 22. Further, the outer peripheral wall 23 is separated from the annular wall 20. Therefore, the separation space 22 extends between the outer peripheral wall 23 and the annular wall 20.

As illustrated in FIG. 6, the annular wall 20 and the outer peripheral wall 23 have the same length in the longitudinal direction. When the battery unit 1 is accommodated in the case 101, an end portion 20a of the annular wall 20 and an end portion 23a of the outer peripheral wall 23 abut on an inner surface 105a of the facing wall 105 of the case 101. For this reason, each of the annular spaces 21 and the separation space 22 are closed.

The first tab 31 and the second tab 40 are embedded in the bottom wall 15 by insert molding. The welded portion 32 of the first tab 31 and the welded portion 42 of the second tab 40 are embedded in a central portion of the lid wall 16 and overlap the through hole 17. The lid wall 16 has a cell facing surface 16a facing an end portion of the cylindrical cell 2. The welded portions 32 and 42 are arranged near an end in the second longitudinal direction X2 of the lid wall 16 and are flush with the cell facing surface 16a.

The wiring portion 33 of the first tab 31 and the wiring portion 43 of the second tab (not illustrated in FIG. 6) are embedded in the bottom wall 15. Further, the wiring portion 33 of the first tab 31 and the wiring portion 43 of the second tab are located at a central portion in the longitudinal direction of the bottom wall 15 (lid wall 16). Therefore, the wiring portion 33 extends inside the bottom wall 15 (lid wall 16) to extend over the partition wall 14a and connect adjacent ones of the cylindrical cells 2 to each other. According to the first tab 31 and the second tab 40 described above which do not have a complicated shape such as a U-shape bend, quality and productivity are improved.

The cell facing surface 16a of the lid wall 16 is provided with a recessed portion 18 recessed in the longitudinal direction. The recessed portion 18 has an annular shape and has a circular shape as viewed in the longitudinal direction (see FIG. 5). By the above, a thin portion 19 having a small thickness in the longitudinal direction is provided in a part of the lid wall 16. Further, the recessed portion 18 (thin portion 19) is arranged inside the annular wall 20 as viewed in the longitudinal direction.

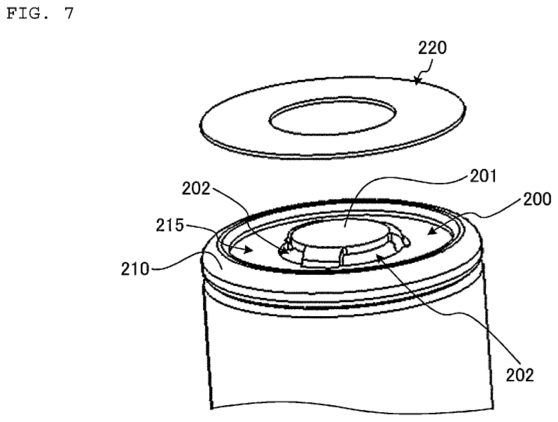

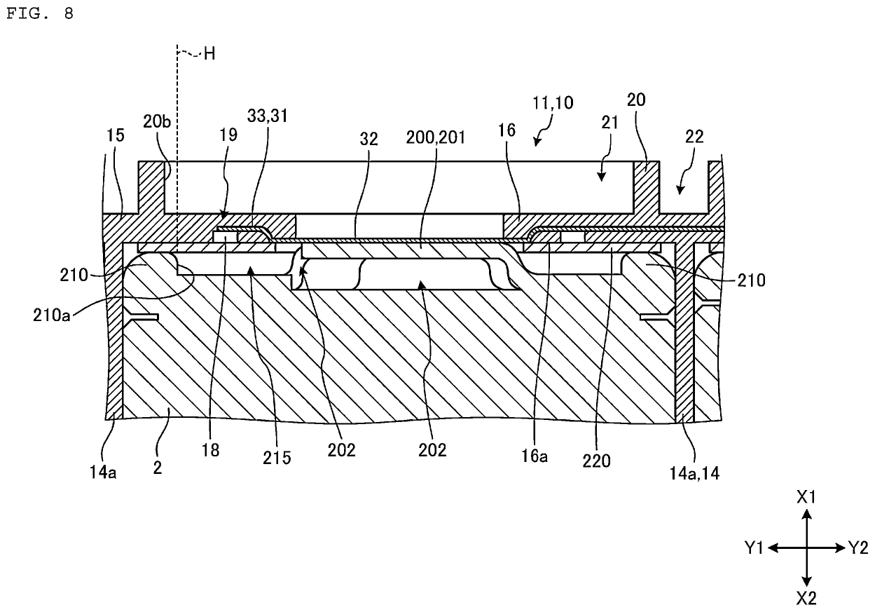

FIG. 7 is a perspective view of an end portion on the positive electrode side of the cylindrical cell. Next, an end portion on the positive electrode side of the cylindrical cell 2 will be described. A top cover 200 is provided at an end portion on the positive electrode side of the cylindrical cell 2. A projecting portion 201 is provided at a central portion of the top cover 200. An opening portion 202 is provided on a side surface of the projecting portion 201. The opening portion 202 is a hole for releasing high-temperature and high-pressure gas ejected from a safety valve (not illustrated) to the outside of the cylindrical cell 2. Further, an annular cell shoulder portion 210 is provided on the outer peripheral side of the top cover 200. An annular battery annular space 215 is provided between the projecting portion 201 and the cell shoulder portion 210. Further, as illustrated in FIG. 7, when the cylindrical cell 2 is assembled to the cell holder 10, an annular seal 220 is arranged between the cell shoulder portion 210 and the cell facing surface 16a (see FIG. 6) of the lid wall 16.

FIG. 8 is a sectional view illustrating a state in which the cylindrical cell is accommodated in the cell accommodation portion. Next, an assembled state of the cylindrical cell 2 with respect to the cell holder 10 will be described. The projecting portion 201 of the cylindrical cell 2 is in contact with the welded portions 32 and 42 (not illustrated in FIG. 8) of the tab 30. Then, welding is performed from the through hole 17, and the welded portions 32 and 42 and the projecting portion 201 are joined.

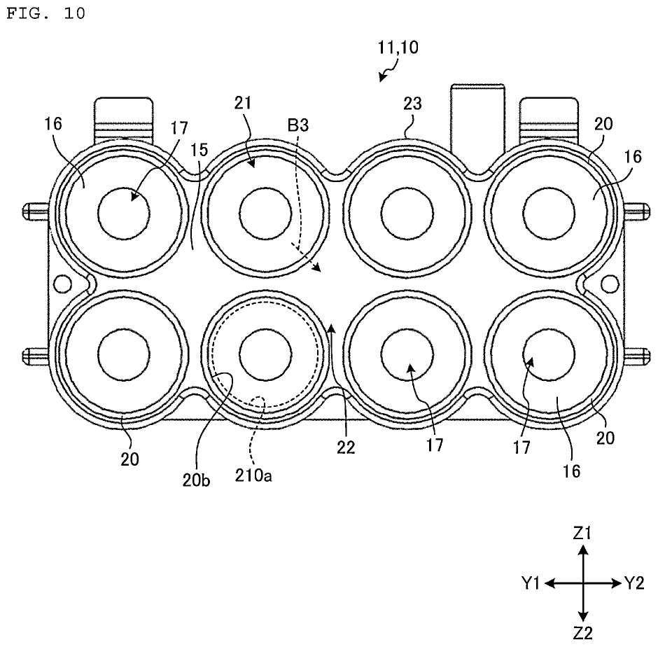

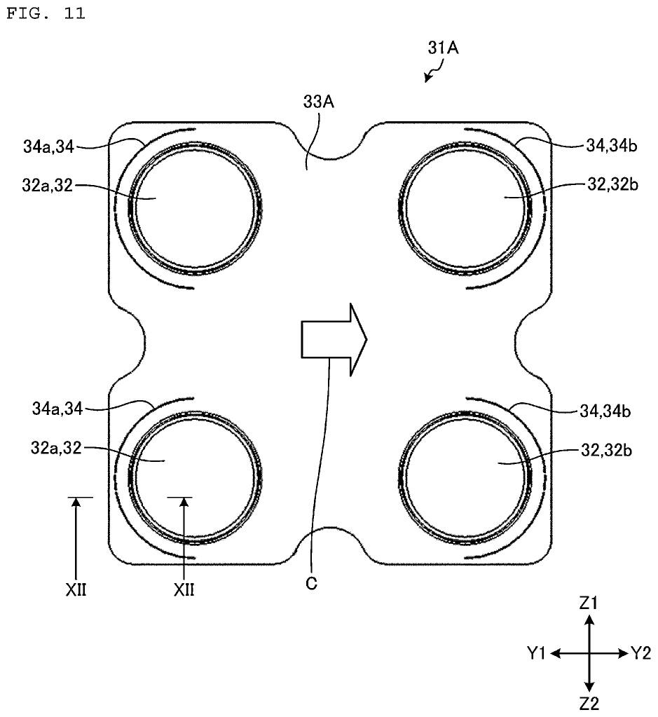

An inner peripheral surface 20b of the annular wall 20 is arranged further on the outer side than an inner peripheral surface 211 of the cell shoulder portion 210 (see auxiliary line H in FIG. 8). Therefore, when viewed from the longitudinal direction, the inner peripheral surface 211 of the cell shoulder portion 210 is located further on the inner side than the inner peripheral surface 20b of the annular wall 20 (see FIG. 10). Further, the battery annular space 215 is closed by the lid wall 16. The seal 220 is arranged between the cell shoulder portion 210 and the cell facing surface 16a, and seals between the cell shoulder portion 210 and the cell facing surface 16a. Further, the recessed portion 18 of the lid wall 16 overlaps the battery annular space 215 when viewed from the longitudinal direction.

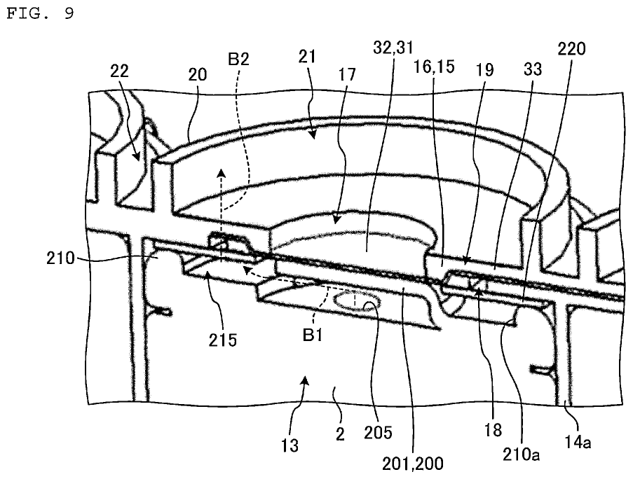

FIG. 9 is a sectional view illustrating a gas path in the cylindrical cell. Next, a gas path in a case where the cylindrical cell 2 generates heat will be described. As illustrated in FIG. 9, when the cylindrical cell 2 generates heat, a safety valve (not illustrated) is opened, and high-temperature and high-pressure gas is ejected from a hole 205. The hole 205 is arranged inside the projecting portion 201 of the top cover 200. As indicated by an arrow B1 in FIG. 9, the gas passes through the opening portion 202 of the projecting portion 201 and flows into the battery annular space 215. Then, internal pressure of the battery annular space 215 increases, and high pressure acts on the lid wall 16 that closes the battery annular space 215.

The lid wall 16 is provided with the thin portion 19. When the battery annular space 215 has a predetermined pressure value or more, the thin portion 19 tears, and a tear (not illustrated) is generated in the lid wall 16. By the above, gas in the battery annular space 215 passes through the tear and moves to the annular space 21 (see arrow B2). Further, the annular space 21 is sealed by the annular wall 20 and the inner surface 105a (see FIG. 6) of the case 101. Thus, gas remains in the annular space 21.

Note that in the lid wall 16, a portion other than the thin portion 19 may be torn. However, a portion of the lid wall 16 on which pressure of gas acts is limited to a portion further on the inner side than an inner peripheral surface 210a of the cell shoulder portion 210. Therefore, if a portion other than the thin portion 19 is torn in the lid wall 16, the tear is further on the inner side than the inner peripheral surface 20b of the annular wall 20. Therefore, gas passing through the lid wall 16 reliably moves to the annular space 21.

FIG. 10 is a sectional view illustrating a gas path in the cell holder. When pressure in the annular space 21 exceeds a predetermined value, the facing wall 105 of the case 101 or the annular wall 20 tears. As illustrated in FIG. 10, in a case where the annular wall 20 tears, gas passes through the tear of the annular wall 20 and moves to the outside of the annular wall 20 as indicated by an arrow B3. The outside of the annular wall 20 is the separation space 22 surrounded by the outer peripheral wall 23. Therefore, the gas remains in the separation space 22.

From the above, gas ejected from the cylindrical cell 2 reliably moves to the annular space 21. For this reason, that the partition wall 14a is cleaved and gas moves to the adjacent cell accommodation portion 13 is avoided.

Further, there is a possibility that gas enters the cell accommodation portion 13 accommodating the cylindrical cell 2 that does not generate heat through the through hole 17 of the lid wall 16. However, the outer side in the longitudinal direction of the through hole 17 is closed by the annular wall 20 and the inner surface 105a of the case 101. Therefore, that gas enters the cell accommodation portion 13 via the through hole 17 is also avoided.

Further, when the annular wall 20 is cleaved, gas remains in the separation space 22. Therefore, that the gas is released into the case 101 and another one of the cylindrical cells 2 is heated is also avoided.

From the above, the cylindrical cell 2 that does not generate heat is prevented from being heated by gas. Further, the above effect is exhibited regardless of processing accuracy of the tab 30.

Although the battery pack of the first embodiment is described above, the present disclosure is not limited to the example shown in the first embodiment. For example, in the first embodiment, the recessed portion 18 is provided on the cell facing surface 16a of the lid wall 16 in order to facilitate cleavage of the lid wall. However, in the present disclosure, the recessed portion 18 may be provided on a surface of the lid wall 16 opposite to the cell facing surface 16a. Alternatively, the recessed portions 18 may be provided on both the cell facing surface 16a and an opposite surface to the cell facing surface 16a (see FIG. 13). Further, in the present disclosure, at least one of the lid wall 16 and the wiring portion 33 only needs to have the thin portion 19. Therefore, the configuration may be such that the thin portion is provided only on the tab 30. Hereinafter, first to third variations in which the thin portion is provided in the tab 30 and a fourth variation in which the thin portion is not provided in the tab 30 will be described. Further, in description below, only a change will be described.

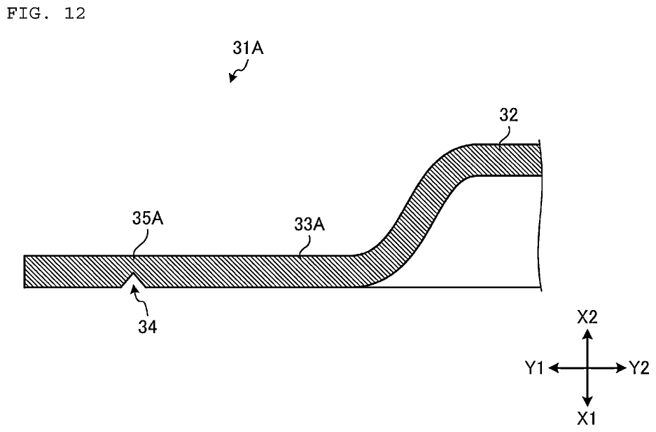

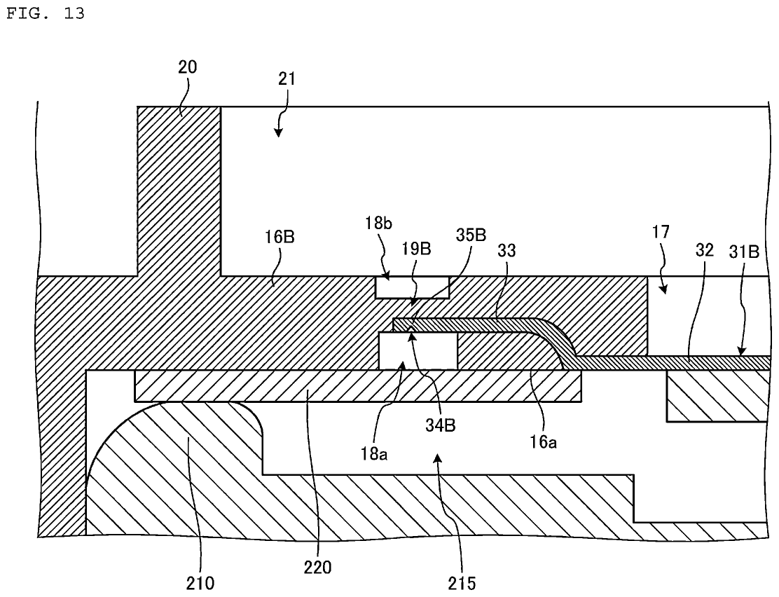

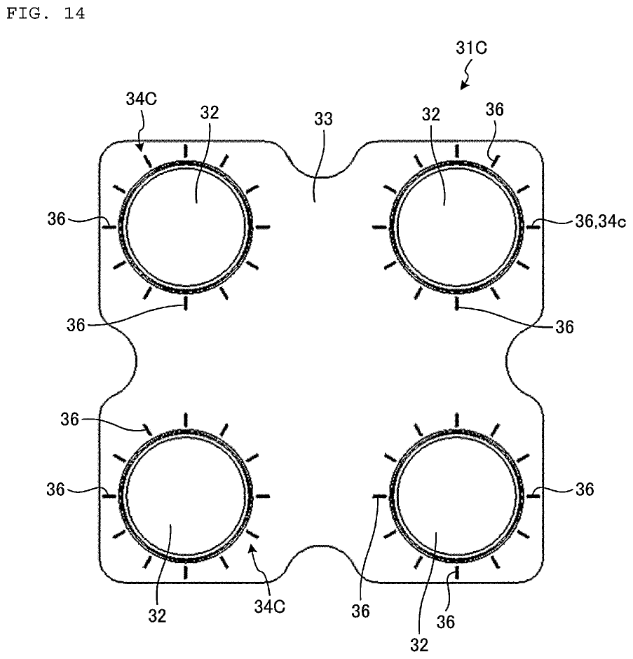

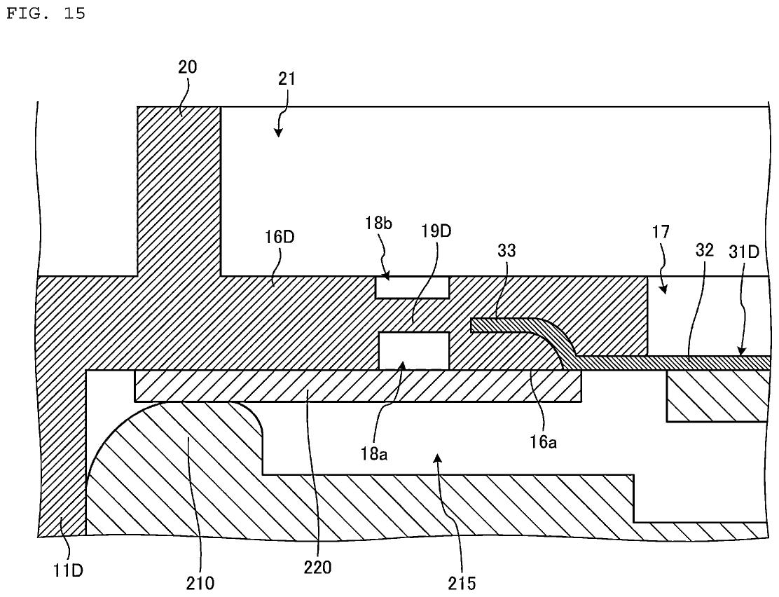

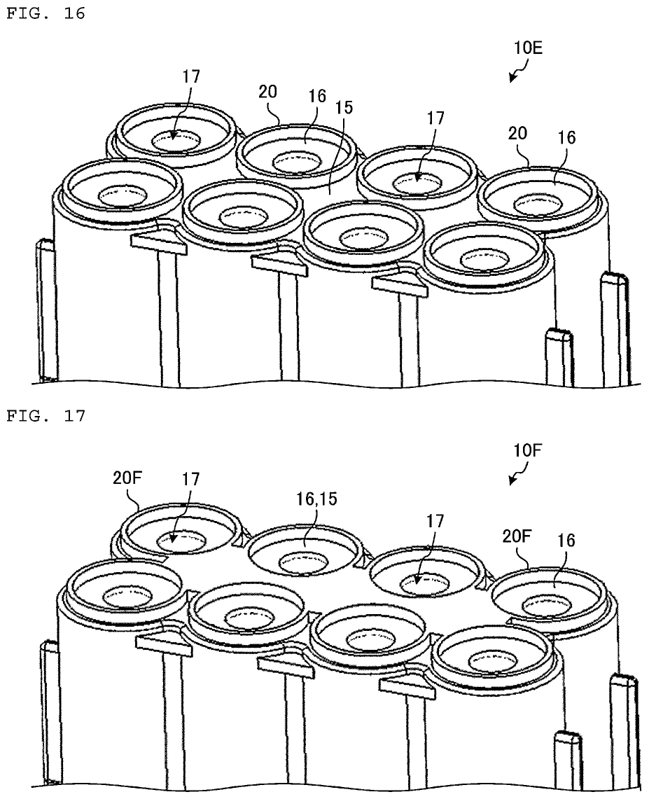

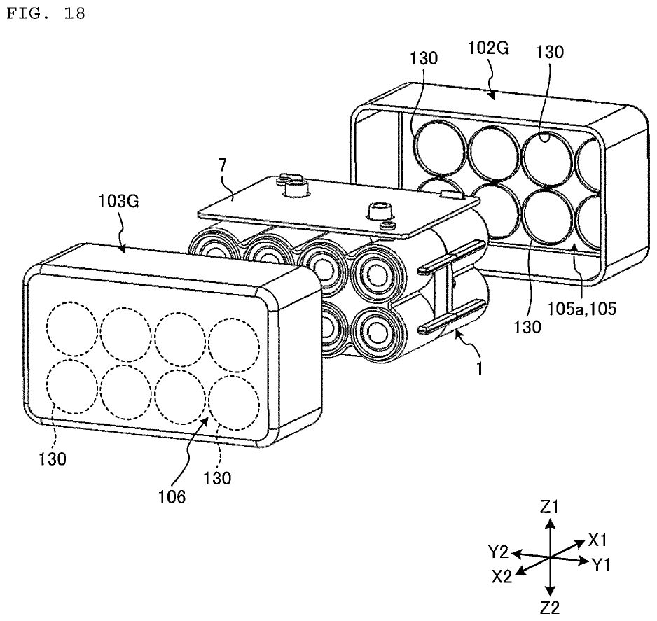

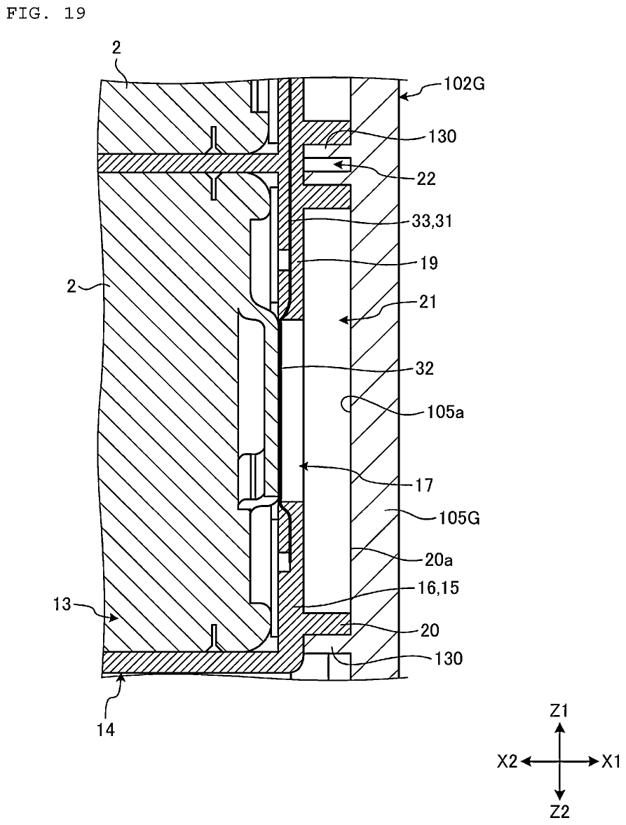

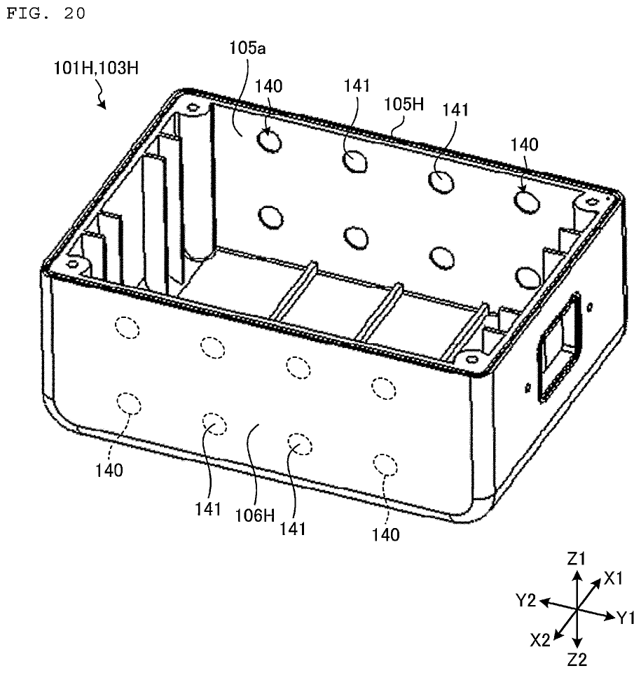

FIG. 11 is a diagram illustrating a first tab of the first variation according to an embodiment. FIG. 12 is a sectional view taken along line XI-XI in FIG. 11. As illustrated in FIG. 11, a semicircular stamp 34 extending along the welded portion 32 is provided on a wiring portion 33A of a first tab 31A of the first variation. As illustrated in FIG. 12, the stamp 34 is a recess formed by pressing a surface of the wiring portion 33A. By the above, a portion of the wiring portion 33A overlapping the stamp 34 is formed as a thin portion 35A having a small thickness in the longitudinal direction.

With the thin portion 35A, regarding strength of the lid wall 16 including the wiring portion 33A, a part of the strength is reduced, and a tear is likely to be generated in the lid wall 16. Therefore, when pressure in the battery annular space 215 exceeds a predetermined value, a portion of the lid wall 16 overlapping the thin portion 35A is cleaved, and gas reliably moves into the annular space 21. Therefore, it is possible to reliably prevent gas from moving to the adjacent cell accommodation portion 13. In the first variation, the stamp 34 is provided on the first tab 31A, but may be provided on the second tab 40.

Further, the first tab 31A is provided with four of the stamps 34 corresponding to four of the welded portions 32. Note that the first tab 31A illustrated in FIG. 12 is arranged at a central portion in the width direction of the first cell holder 11 (see FIG. 3). In the first tab 31A illustrated in FIG. 12, two of the welded portions 32 arranged near the second width direction Y2 are negative electrode welded portions 32b welded to the negative electrode terminal 5 of the cylindrical cell 2. Two of the welded portions 32 arranged near a first width direction Y1 are positive electrode welded portions 32a welded to the positive electrode terminal 4 of the cylindrical cell 2. Therefore, in the wiring portion 33A, current flows from the positive electrode welded portion 32a toward the negative electrode welded portion 32b (see an arrow C in FIG. 11).

A stamp 34b extending along the negative electrode welded portion 32b is arranged on the opposite side to the positive electrode welded portion 32a as viewed from the negative electrode welded portion 32b. The stamp 34b extending along the positive electrode welded portion 32a is arranged on the opposite side to the negative electrode welded portion 32b as viewed from the positive electrode welded portion 32a. That is, the stamp 34 (34a, 34b) is not arranged between the negative electrode welded portion 32b and the positive electrode welded portion 32a. A portion where the stamp 34 is provided has a large resistance value. Therefore, according to the first variation, that a resistance value between the negative electrode welded portion 32b and the positive electrode welded portion 32a becomes high is avoided.

FIG. 13 is an enlarged diagram enlarging the first cell holder according to the second variation according to an embodiment. The second variation is a variation in which a thin portion 19B and a thin portion 35B are provided in a lid wall 16B and a first tab 31B, respectively. Specifically, in the lid wall 16B, a first recessed portion 18a is provided on the cell facing surface 16a, and a second recessed portion 18b is provided on a back surface. The first recessed portion 18a, the second recessed portion 18b, and a stamp 34B overlap in the longitudinal direction. That is, the thin portion 19B and the thin portion 35B overlap each other. According to this, the thin portion 19B and the thin portion 35B are cleaved at pressure lower than that in the first embodiment. For this reason, gas in the battery annular space 215 can be reliably released into the annular space 21.

FIG. 14 is a diagram illustrating the second tab of a third variation according to an embodiment. As illustrated in FIG. 14, a stamp 34C of a first tab 31C of the third variation includes a plurality of linear stamps 36 radially extending from the welded portion 32. The linear stamps 36 are arranged at equal intervals around the welded portion 32. As described above, in the present disclosure, a shape of the stamp is not particularly limited.

FIG. 15 is an enlarged diagram enlarging the first cell holder according to a fourth variation according to an embodiment. In the first cell holder 11D of the fourth variation, a lid wall 16D is provided with the first recessed portion 18a and the second recessed portion 18b. On the other hand, a first tab 31D is not provided with a stamp. Further, the first recessed portion 18a and the second recessed portion 18b are provided in a range not overlapping the first tab 31D as viewed in the longitudinal direction. According to the above, the first tab 31D is not embedded in a thin portion 19D between the first recessed portion 18a and the second recessed portion 18b. Therefore, the thin portion 19D is made only from resin, and the first tab 31D made from metal does not need to be cleaved, and therefore cleavage occurs at lower pressure. Next, a variation in which a portion other than the thin portion is modified will be described.

FIG. 16 is a perspective view of the bottom wall side of the cell holder of a fifth variation according to an embodiment. A cell holder 10E of the fifth variation is different from that of the first embodiment in that the outer peripheral wall 23 (see FIG. 5) is not provided on the bottom wall 15. In the cell holder 10E of the fifth variation as well, cleavage occurs in the lid wall 16, and gas in a battery annular space 115 moves to the annular space 21. Therefore, gas is prevented from entering the adjacent cell accommodation portion 13.

FIG. 17 is a perspective view of the bottom wall side of the cell holder of a sixth variation according to an embodiment. A cell holder 10F of the sixth variation is common to the fifth variation in that the outer peripheral wall 23 (see FIG. 5) is not provided on the bottom wall 15. On the other hand, the cell holder 10F of the sixth variation is different from that of the fifth variation in that annular walls 20F are continuous. That is, the cell holder 10F of the sixth variation does not have the separation space 22. According to the sixth variation, the annular wall 20F is formed to be thick. Therefore, the annular wall 20F is hardly cleaved, and that gas is released into the case 101 can be avoided.

FIG. 18 is an exploded perspective view of the battery pack of a seventh variation according to an embodiment. FIG. 19 is a sectional view of the seventh variation. A case 101G of the seventh variation is different from the case 101 of the first embodiment in including a first case 102G and a second case 103G that can be divided in the longitudinal direction. The first case 102G and the second case 103G are bottomed cylindrical containers. The first case 102G and the second case 103G have a pair of facing walls 105G and 106G facing each other in the longitudinal direction. Eight cylindrical fitting portions 130 are provided on the inner surfaces 105a of a pair of the facing walls 105G and 106G (an inner surface of the facing wall 105G is not illustrated in FIG. 18). Eight of the fitting portions 130 are arranged with four in the width direction and two in the stacking direction so as to correspond to the annular wall 20.

As illustrated in FIG. 18, the fitting portion 130 is fitted to the outer side of the annular wall 20. According to this, also in a case where the facing wall 105G is deformed or length of the annular wall 20 is shortened due to a manufacturing error, and the end portion 20a of the annular wall 20 does not abut on the inner surface 105a, the annular space 21 is reliably sealed. Therefore, gas leakage from between the annular wall 20 and the facing wall 105G is avoided.

The seventh variation is described above. Although the fitting portion 130 of the seventh variation is configured to be fitted to the outer side of the annular wall 20, the present disclosure may be a fitting portion that is fitted to the inner side of the annular wall 20. Further, as shown in the seventh variation, in a case where the fitting portion 130 is provided in the case 101G, the end portion 20a of the annular wall 20 of the present disclosure does not need to abut on the inner surface 105a of the facing wall 105G. Further, in the seventh variation, the example in which the fitting portion 130 is provided in the first case 102G and the second case 103G that can be divided in the longitudinal direction is described. However, in the present disclosure, the fitting portion 130 may be provided in the case 101 of the first embodiment divided in the stacking direction.

FIG. 20 is a perspective view illustrating the second case of an eighth variation according to an embodiment. As illustrated in FIG. 20, a second case 103H of the eighth variation is different from the second case 103 of the first embodiment in that a plurality of recessed portions 140 are provided on the inner surfaces 105a of a pair of the facing walls 105 and 106 (an inner surfaces of the facing wall 106 is not illustrated). According to the above, in each of a pair of the facing walls 105 and 106, thickness in the longitudinal direction of a portion overlapping the recessed portion 140 is reduced. Hereinafter, a portion overlapping the recessed portion 140 is referred to as a fragile portion 141. Further, the fragile portion 141 is arranged on the inner side of the annular wall 20 when viewed in the longitudinal direction. Therefore, in a case where the annular space 21 of the annular wall 20 is filled with gas, the fragile portion 141 is easily cleaved. That is, gas is released to the outside of a case 101H, and the inside of the case 101H is not filled with the gas. Note that, in the the eighth variation, the recessed portion 140 is provided on the inner surfaces 105a of a pair of the facing walls 106 and 105. However, in the present disclosure, the recessed portion 140 may be provided on outer surfaces of a pair of the facing walls 105 and 106.

### DESCRIPTION OF REFERENCE SYMBOLS

1: Battery unit
2: Cylindrical cell
3: Electrode terminal
10, 10E, 10F: Cell holder
11, 11D: First cell holder
12: Second cell holder
13: Cell accommodation portion
14: Holder main body
15: Bottom wall
16, 16B, 16D: Lid wall
17: Through hole
18: Recessed portion
19, 19B: Thin portion
20, 20F: Annular wall
21: Annular space
22: Separation space
23: Outer peripheral wall
30: Tab
31, 31A, 31B: First tab
32, 42: Welded portion
32a: Positive electrode welded portion
32b: Negative electrode welded portion
33, 33A, 43: Wiring portion
34, 34B, 34C: Stamp
35A, 35B: Thin portion
36: Linear stamp
40: Second tab
100: Battery pack
101, 101G, 101H: Case
102, 102G: First case
103, 103G, 103H: Second case
105, 106: Facing wall
105a: Inner surface
130: Fitting portion
140: Recessed portion
141: Fragile portion
200: Top cover
201: Projecting portion
202: Opening portion
210: Cell shoulder portion
215: Battery annular space
220: Seal

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery pack comprising:
a plurality of cylindrical cells arranged in a manner that a plurality of electrode terminals face a same direction;
a cell holder made from resin that holds arrangement of the plurality of cylindrical cells;
a tab made from metal extending in a planar direction parallel to a direction orthogonal to a longitudinal direction of the cylindrical cell; and
a case that accommodates a plurality of the cylindrical cells, the cell holder, and the tab,
wherein the cell holder includes:
a holder main body in which a plurality of cell accommodation portions extending in the longitudinal direction are provided in the planar direction;
a bottom wall extending in the planar direction and connected to an end portion of the holder main body; and
a through hole penetrating the bottom wall,
the bottom wall includes:
a plurality of lid walls covering the cell accommodation portion; and
a plurality of annular walls extending from the lid wall toward an inner surface of the case,
the tab includes:
a plurality of welded portions which are arranged on each of a plurality of the lid walls and are welded to the electrode terminal through the through hole; and
a wiring portion that extends in the planar direction from the welded portion and connects the welded portions to each other,
at least one of the lid wall and the wiring portion is provided with a thin portion having small thickness in the longitudinal direction, and
the thin portion is arranged on an inner side of the annular wall as viewed from the longitudinal direction.

2. The battery pack according to claim 1, wherein the wiring portion is embedded in the lid wall.

3. The battery pack according to claim 1, wherein
the lid wall is provided with a recessed portion recessed in the longitudinal direction, and
the thin portion is provided on the lid wall.

4. The battery pack according to claim 1, wherein
the wiring portion is provided with a stamp recessed in the longitudinal direction, and
the wiring portion is provided with the thin portion.

5. The battery pack according to claim 3, wherein
the wiring portion is provided with a stamp recessed in the longitudinal direction,
the stamp and the recessed portion overlap each other as viewed in the longitudinal direction, and
the thin portion is provided in each of the lid wall and the tab.

6. The battery pack according to claim 4, wherein
the welded portion includes:
a positive electrode welded portion welded to a positive electrode terminal of the electrode terminal; and
a negative electrode welded portion welded to a negative electrode terminal of the electrode terminal, and
the stamp is arranged on an opposite side to the positive electrode welded portion as viewed from the negative electrode welded portion or on an opposite side to the negative electrode welded portion as viewed from the positive electrode welded portion.

7. The battery pack according to claim 1, wherein
a projecting portion of a top cover welded to the welded portion is arranged at a central portion of an end portion on a positive electrode side of the cylindrical cell,
a cell shoulder portion forming an annular shape around the projecting portion is provided at an edge portion of an end portion on a positive electrode side of the cylindrical cell,
a battery annular space serving as a gas passage is provided between the projecting portion and the cell shoulder portion, and
an inner peripheral surface of the cell shoulder portion is arranged on an inner side of an inner peripheral surface of the annular wall as viewed from the longitudinal direction.

8. The battery pack according to claim 1, wherein
a separation space that separates the annular walls from each other is provided between a plurality of the annular walls, and
the bottom wall is provided with an annular outer peripheral wall surrounding an outer peripheral side of a plurality of the annular walls and the separation space.

9. The battery pack according to claim 1, wherein a plurality of the annular walls are continuous with an adjacent one of the annular walls.

10. The battery pack according to claim 1, wherein an end portion of the annular wall is in contact with an inner surface of the case.

11. The battery pack according to claim 1, wherein a plurality of fitting portions fitted to the annular wall is provided on an inner surface of the case.

12. The battery pack according to claim 1, wherein
a plurality of fragile portions having small thickness in the longitudinal direction are provided on an inner surface of the case, and
the fragile portion is arranged on an inner side of the annular wall as viewed from the longitudinal direction.
